(19) United States
(12) Patent Application Publication
(10) Pub. No.: US 2021/0286921 A1
(43) Pub. Date: Sep. 16, 2021

(54) GENERATING STYLE GRAMMARS FOR GENERATIVE DESIGN

(71) Applicant: Accenture Global Solutions Limited, Dublin (IE)

(72) Inventors: Michael Kuniavsky, San Francisco, CA (US); Nicholas Akiona, San Jose, CA (US); Michael Nai-An Chen, San Francisco, CA (US)

(21) Appl. No.: 17/202,489

(22) Filed: Mar. 16, 2021

Related U.S. Application Data
(60) Provisional application No. 62/990,266, filed on Mar. 16, 2020.

(51) Int. Cl. G06F 30/20

(52) U.S. Cl. CPC G06F 30/20; G06F 2111/04

(57) ABSTRACT

This document describes a generative design platform that generates and uses style grammars to generate product designs. In one aspect, a method includes, for each of multiple products, obtaining one or more visual representations of the product and extracting, from the one or more visual representations of the product, feature values for visual features of the product. For each visual feature of a set of visual features, one or more clusters are generated. Each cluster includes a set of feature values for one or more of the products classified as being similar feature values. For a group of related products, a style grammar is generated based on the set of feature values assigned to each cluster. The style grammar for the group of related products includes a set of stylistic parameters that specify respective ranges of feature values for visual features that represent aesthetic characteristics of the group of products.

### CROSS REFERENCE TO RELATED APPLICATIONS

This application claims the benefit of U.S. Patent Application No. 62/990,266, filed Mar. 16, 2020, which is incorporated herein by reference.

### TECHNICAL FIELD

This specification relates to computer-aided design (CAD), and particularly to generative product design platforms.

### BACKGROUND

Computer-aided design (CAD) is used across multiple industries for the design and manufacture of products. Generally, CAD programs boost the productivity of designers, reduce lead times in the concept-to-manufacture pipeline, and increase the overall quality of products. CAD programs enable designers to use computers to create, modify, analyze, and optimize product designs. Some CAD programs enable virtual testing of product designs prior to physical prototyping and/or manufacturing. The product design is stored in a computer-readable file (CAD file), which can be used in subsequent phases of the design process.

### SUMMARY

This specification generally describes a generative design platform that generates style grammars based on features extracted from visual representations, e.g., images, of products and uses the style grammars in a generative design process to generate product designs that maintain key visual aspects of a core stylistic design.

Traditional CAD, where a single geometric model is laboriously manipulated by a highly trained expert, does not scale to one-off products. When you have “n of 1” manufacturing capability, every object can be different, such as objects produced using multi-material additive manufacturing, but the design burden is enormous. Generative design tools can iterate through many different designs and output product designs that meet a set of constraints. This process can automatically take into account constraints, such as strength, weight, and cost while being able to design things that fall outside of people's imaginations and past experiences. Generative design technology can use topological optimization to minimize material use while maintaining mechanical performance.

While generative design can be great at enhancing parts for features such as weight and cost, generative design can be enhanced by considering, as constraints, an organization's or a user's design aesthetic preferences. A generative design system based on style grammars can generate product designs that are based on aesthetic constraints, in addition to functional, manufacturing, cost, and/or other appropriate constraints.

Style grammars are geometric constraints that describe a design space with infinite variations, while maintaining key aspects of the core design vision. The style grammar-based generative design system described in this document provides a framework for developing product designs that fit the style of a brand or other group of related products. End users may not know explicitly what visual design elements define a company's in-house style. Such users can use style grammars in a generative design process to converge upon a set of designs that may be unique, but still retain the core visual characteristics of the brand. This enables individuals to make a one-off design that is manufacturable by computer-controlled tools, while having the overall style of the brand.

The use of style grammars in a generative design process increases the speed at which products that conform with a brand identity are designed, which can reduce the computational resources required to generate product designs. For example, using style grammars can reduce the number of iterations of a generative design process required to find a suitable product design that meets both performance constraints and stylistic constraints of a group of related products. Reducing the number of iterations to converge on suitable product designs reduces the computation burden placed on computing systems, freeing up resources for other tasks. This can enable the design of new products to scale exponentially rather than linearly due to the increase in speed and reduced number of iterations to find suitable designs.

Automatically generating style grammars for a group of related products using images and/or CAD files for the products enables the detection of unique stylistic features that are important to the group of products and that may not be noticed by human designers. The platform can evaluate features of the group of products over time and/or relative to products manufactured by others to identify the important features of the group of products and use this information to constrain the generative design process and evaluate product designs generated by the generative design process. This provides an objective measure of the important stylistic features of the group of products so that generatively designed products more accurately conform to the aesthetic characteristics of the group of products. Using such automatically generated parameters reduces the amount of wasted computational resources in generating product designs that have the stylistic look and feel of a brand or other group of products, relative to processes that do not take into account such parameters and/or is based on subject human evaluation of the features represented by the parameters.

Generative design systems generally perform an iterative process of generating candidate designs, evaluating these designs, and ranking the designs, as part of the generative design process. Unlike conventional systems, the generative design platforms described in this document can avoid generating, evaluating, and ranking product designs that the system knows do not fit within a brand's design grammar, thereby avoiding the needless consumption of computational resources on unused candidate designs, and focusing computational resources on the evaluation of a narrower band of designs that fit within a predefined brand schema. A style grammar can specify acceptable ranges of visual features of components that limit the generative design process to only candidate product designs that fit the brand schema. For example, a style grammar can specify that the number of spokes of a wheel must be between five to seven spokes to fit the aesthetic style of a brand. This forces the generative design process to only generate and evaluate designs having a number of spokes within that range, thereby avoiding wasting resources evaluating designs having more or fewer spokes that would ultimately not be selected as a final design or that would fail a final review process.

In general, one innovative aspect of the subject matter described in this specification can be embodied in methods that include the actions of, for each product of multiple products, obtaining one or more visual representations of the product and extracting, from the one or more visual representations of the product, feature values for visual features of the product. For each visual feature of a set of visual features, one or more clusters are generated. Each cluster includes a set of feature values for one or more of the products classified as being similar feature values. For a group of related products, a style grammar is generated based on the set of feature values assigned to each cluster. The style grammar for the group of related products includes a set of stylistic parameters that specify respective ranges of feature values for visual features that represent aesthetic characteristics of the group of related products. A generative design process is performed using the generated style grammar to generate multiple candidate product designs for a given product of the group of related products. Data that causes a client computing device to present a visual representation of one or more of the multiple candidate product designs is provided to the client computing device.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. In some aspects, obtaining the one or more visualization representations of each product includes obtaining a set of images of the product, identifying a given type of the product, identifying a specified perspective for images that are used for generating style grammars for products of the given type, selecting, as the one or more visual representations of the product, one or more images captured from the specified perspective.

Some aspects include receiving, from a client computing device of a user, data identifying a set of design parameters comprising a product template for the given product and the generated style grammar; obtaining, for the given product, one or more physical constraints on a design of the given product; generating, by evaluating each candidate product design, a set of scores for each candidate product design, the set of scores including a style score representing a measure of how well the candidate product design conforms to ranges of visual features that represent the aesthetic characteristics of the generated style grammar and a performance score representing a measure of how well the candidate product design satisfies one or more performance objectives for the given product, wherein the candidate product designs are generated based on the generated style grammar, the product template, and the one or more physical constraints; selecting, based on the set of scores for each candidate product design, the one or more candidate product designs.

In some aspects, generating the set of clusters includes, for each visual feature of the set of visual features, generating one or more clusters that each includes feature values for the group of related products. In some aspects, generating, for the group of related products, the style grammar based on the set of visual features assigned to each cluster includes determining, for each given visual feature of the group of related products, a measure of importance of the given visual feature based on the feature values assigned to each cluster and assigning a weight to each given visual feature based on the determined measure of importance for the given visual feature.

Some aspects include, for each candidate product design, determining, based on a feature value for each given visual feature of the candidate design and the weight assigned to each given visual feature, a score for the candidate design and selecting the one or more of the candidate designs based on the score for each candidate design.

In some aspects, generating, for a group of related products, the style grammar based on the set of feature values assigned to each cluster includes identifying, for a given visual feature, the range of the feature values for the group of related products assigned to a same cluster.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example environment in which a generative design platform generates product designs using style grammars.

FIG. 2 shows a process for generating product designs using a style grammar.

FIG. 3 is a flow diagram of an example process for generating product designs using style grammars.

FIG. 4 is a flow diagram of an example process for generating a style grammar for a product or a group of related products.

FIG. 5 shows a process for generating a style grammar.

FIG. 6 is a block diagram of a computing system that can be used in connection with computer-implemented methods described in this document.

Like reference numbers and designations in the various drawings indicate like elements.

### DETAILED DESCRIPTION

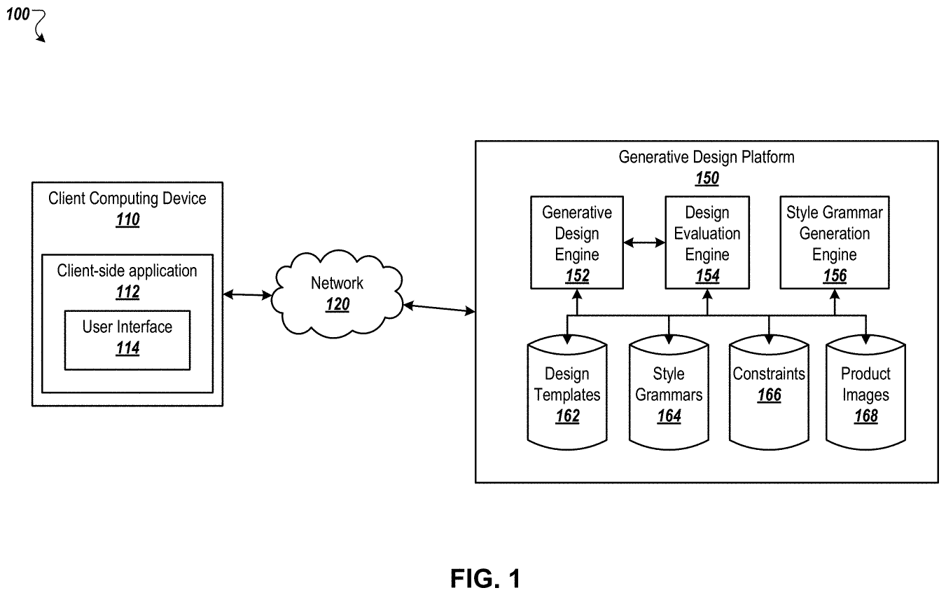

FIG. 1 shows an example environment 100 in which a generative design platform 150 generates product designs using style grammars. As shown in FIG. 1, a generative design platform 150 generates product designs using a generative design process that is based on a set of parameters that includes style grammars. A style grammar is a set of stylistic parameters that define aesthetic characteristics of a group of related products. A style grammar can define the aesthetic characteristics that are common to, or found in, a group of related products. For example, a company can generate style grammars that specify aesthetic constraints that match its brand. In another example, the generative design platform can generate a style grammar for a group of products automatically based on visual representations to the products, e.g., based on images and/or CAD representations of the products, and optionally visual representations of other products. A style grammar can capture, parametrically, the brand's design aesthetics and user stylistic preferences such that a computer system can use the style grammar to generate product designs that conform to the design aesthetics and/or satisfies stylistic constraints imposed on the design by the parameters of the style grammar.

The generative design process can include generating a set of candidate product designs for a product based on a template for the product, one or more style grammars, physical constraints in the design of the product, e.g., required materials, size, relationship between parts, etc., and/or performance objectives for the product. The generative design process can include multiple iterations and, at each iteration, the generative design platform can score the candidate product designs based on multiple factors, e.g., how well the candidate product design conforms to the aesthetic characteristics of the style grammar(s), the functional performance of the candidate product design, the manufacturability of the candidate product design, and/or other appropriate factors. The generative process can perform multiple iterations until converging on a set of candidate product designs for which information is presented to a user.

After each iteration or a set of iterations, a user can select a subset of the candidates to fine tune the process for the next iteration. The generative design platform 150 can use the user selections to identify visual characteristics of the product design that are important to the user and use the feedback as parameters in the next iteration of the generative design process. For example, the generative design platform 150 can identify similarities between the selected candidate product designs and/or their scores and use that information in the next iteration(s). The generative design platform 150 can also identify differences between the selected candidate product designs and the non-selected product designs and use those differences as parameters in the next iteration(s).

Using such a generative design process enables the generative design platform 150 to generate product designs that have the look and feel of a group of products, e.g., of a brand or a group of products within a brand, while also satisfying the performance objectives for the product. It also enables the product designs to be adapted to user preferences using an iterative feedback process. Absent such techniques, it would be impractical for a company to generate many one-off products that have aesthetic characteristics that conform to the overall style of a brand or other group of related products.

In FIG. 1, the environment 100 includes a data communication network 120, such as a local area network (LAN), a wide area network (WAN), the Internet, a mobile network, or a combination thereof. The network 120 connects client computing devices 110 to the generative design platform 150.

The client computing device 110, which can be in the form of a personal computer or mobile device, includes a client-side application 112 that enables the user to interact with the generative design platform 150. For example, the client-side application 112 can generate and present user interfaces 114 that enable the user to interact with the generative design platform 114. This interaction enables the user to collaborate with the generative design platform 150 to generate product designs that have aesthetic characteristics that conform to the style of a brand or other group of related products.

The user interfaces 114 enable the user to select or otherwise provide inputs to the generative design process. These inputs can include, for example, a product template, one or more style grammars, information about another product with which the designed product will be used, and/or information about the user of the product. The inputs can also include user preferences for the style of the product, e.g., in the form of parameters defining visual characteristics of the product design.

The user interfaces 114 also enable the user to refine or customize the generative design process. For example, the generative design platform 150 can provide information about candidate product designs for display by the user interfaces 114. This information can include, for each candidate product design, a visual representation, e.g., a computer-generated image, of the candidate product design. This information can also include one or more scores related to the candidate product design. The user can select candidate product designs that the user prefers and the client-send application 112 can send information identifying the selected candidate product designs to the generative design platform 150. The candidate design platform 150 can then update the parameters for the generative design process for subsequent iterations based on the selected candidate product designs.

These interactive user interfaces enable users to access and understand the constraints needed for different product designs and different use cases, and improves their ability to generatively design products that are safe, efficient, and appealing to others. The user interfaces also enable close collaboration between a human user and a computing platform, which can include artificial intelligence (AI) engines such that the platform is an AI assistant in the design process. By providing scores related to aesthetics, performance, and manufacturability along with the visual representations of the candidate product designs, users can easily identify the characteristics that are important in the product design and better select candidate product designs that are used to update the next iteration of the generative design process.

The generative design platform 150, which can be in the form of one or more computers, includes a generative design engine 152, a design evaluation engine 154, and a style grammar generation engine 156. Although shown as three separate engines, the functionality of the three engines can be combined into the same software and/or hardware. The engines can employ artificial intelligence and/or machine learning techniques to generate candidate product designs, evaluate the candidate product designs, and generate style grammars for use in generating and evaluating the product designs.

The generative design engine 152 generates multiple candidate product designs based on the inputs received from the user and additional characteristics and/or constraints on the product being designed. The generative design engine 152 can generate the candidate product designs using an iterative process in which the generative design engine 152 generates multiple candidate designs based on the various inputs. The design evaluation engine 154 can evaluate the candidate product designs can generate one or more scores for each candidate product design based on the evaluation. The generative design engine 152 can select some of the candidate product designs based on the one or more scores, e.g., based on a combination of the one or more scores, and provide information about the selected candidate designs to the client computing device 110 for display to the user using a user interface 114. The generative design process can include multiple iterations in which candidate product designs are generated and scored, with each iteration being different based on the candidate product designs selected by the user at each iteration. By only considering designs that conform to parameters defined by style grammars and other constraints, computation resources of the generative design platform 150 are not wasted on useless candidate product designs. This enables the generative design platform 150 to focus on improving, e.g., maximizing scores of, conforming product designs resulting in better product designs using the same or fewer computational resources.

The inputs to the generative design process can include a product template that is selected by the user. The generative design platform 150 can maintain a design template database 162, or other appropriate data structure, that includes templates for multiple products, including multiple templates for each product or each type of product. The templates for a product can include variations of the product. For example, the templates for a rim for a vehicle can include templates for various size rims, templates for rims having different quantities of spokes, templates for different types of vehicles, e.g., some for sports cars and others for large trucks or heavy machinery.

In general, a template can specify baseline characteristics of the product and or valid ranges for these characteristics. For example, a template can specify a baseline size of each part of the product, a baseline shape of each product, material(s) that can be used for each part of the product, relationships between the parts, e.g., orientation, physical separation, attachment points, and/or attachment mechanisms, and/or other appropriate baseline characteristics of the product. At least some of these characteristics are modified by the generative design engine 152 when generating the candidate product designs.

A template can also include post-processing instructions. For example, the post-processing instructions can instruct the generative design engine 152, or another engine or system, on how to generate a complete product design based on a generatively designed subcomponent. In a particular example, a template for a wheel can include the baseline characteristics for a slice of the wheel and instructions for generating a complete wheel based on a slice of a wheel that is generatively designed using the template, the style grammar(s), etc.

The inputs to the generative design process also includes one or more style grammars. A style grammar is a set of stylistic parameters that define aesthetic characteristics of a group of related products. The generative design platform 150 can maintain a style grammar database 164, or other appropriate data structure, that includes style grammars for groups of products, e.g., brands, and/or subgroups. For example, there can be a style grammar for an overall brand and a style grammar for each type or other subgroup of products within the brand. In a particular example, the generative design platform 150 can include an overall style grammar for an athletic apparel manufacturer, a style grammar for golf related products, and a style grammar for basketball related products. Some or all of these style grammars can be generated by the generative design process, as described below.

Each parameter of a style grammar can correspond to a visual feature of a product or group of products. The parameter can specify a feature value or range of feature values for the product or the group of products. For example, a visual feature can be a color. The parameter for the color of the product(s) can indicate a particular color, a range of colors, or a color palette for the product(s). Each color is a feature value for the visual feature.

In general, a style grammar encodes a brand identity into a parametric description of a product or group of products. The stylistic parameters can define constraints on the characteristics of candidate product designs. For example, the stylistic parameters can include required characteristics and/or ranges of feature values for visual features that represent aesthetic characteristics of a brand. The generative design engine 152 can exclude any candidate designs that do not satisfy these constraints. For example, a style grammar can specify that, for a candidate design of a rim to match the stylistic design for sports rims of a particular brand, the candidate rim must have 4-6 spokes that occupy between 25-35% of the area between the outer edge of the center bore and the inner edge of the outer lip. Candidate designs that do not meet these constraints can be filtered from the generative design process. The range in the quantity of spokes and the range in consumed area are parameters defined by the style grammar corresponding to visual features of rims.

The stylistic parameters can also define characteristics against which candidate product designs can be evaluated and scored. For example, the stylistic parameters can define a target feature value or a range of feature values each having a corresponding score. For example, a visual characteristic can be a relative proportion of one part of a product, e.g., the roofline of a car, to the proportion of another part of the product, e.g., the wheelbase of the car. In this example, the closer the relative proportion of a candidate product design is to the target relative proportion, the higher the stylistic score for the candidate product design would be.

A style grammar can include parameters for various visual characteristics of a product. Some examples of these parameters include the size of a logo, the position of the logo on the product, color(s) of the product, materials of the product or each part of the product, the finish of the product or each part of the product, how curves are treated, e.g., the curvature comb, how transitions between curves are handled, corner radii, and relative proportion between parts of subcomponents. These visual characteristics can vary based on the product or type of product.

The style grammar can define the acceptable values and/or ranges of values for each visual characteristic. The use of ranges rather than specific values enables the generative design engine 152 to generate more product designs that users would likely not imagine on their own. For example, a style grammar for a brand can include a color palette of ranges of acceptable shades of colors and/or color combinations that define the style of the brand. The generative design engine 152 can use these customizable parameters to generate many different candidate product designs, and the users can refine the design process based on their selections to arrive at product designs that fit the style of the brand, satisfies other objectives, e.g., performance and/or manufacturability, and looks appealing to the users.

A style grammar can also be used to specify one or more obstacle bodies. An obstacle body defines an area of a product where material cannot be added. For example, a functional obstacle body can define that material cannot be added over the lug hole for inserting a lug nut through a rim as that would obstruct the lug hole making it non-functional. Functional obstacle bodies can be part of the template, a style grammar, or another constraint used by the generative design platform 150.

A stylistic obstacle body, which can be generated based on a style grammar, can prevent the generative design engine 152 from adding material to areas where it would change the aesthetics of the product such that aesthetics do not conform to the style defined by the style grammar. For example, an edge of products of a particular brand may have an angular design. Adding material to this edge may cause it to not have an angular appearance and thus not conform to the style of the brand. In another example, a stylistic obstacle body can specify that material cannot be added over an area that will include a logo. For a stylistic obstacle body, the style grammar can include an obstacle body parameter that specifies each area of the product where additional material cannot be added.

The generative design engine 152 can generate one or more stylistic obstacle bodies for the generative design process based on the style grammar(s). For example, the generative design engine 152 can generate multiple variations of a stylistic obstacle body for a particular part of a product based on the style grammar(s). That is, the generative design engine 152 can determine, based on the parameters of the style grammar(s), areas of the product where, if additional material were added, it would result in a product design that does not conform to the aesthetic characteristics for the product, as defined by the style grammar(s). In a particular example, a particular edge of each product may have a rounded look with a radius within a particular range. Adding material along the edge or either side of the edge may result in an out-of-range radius or a non-curved edge. Based on the requirements of the edge as defined by the parameters of the style grammar(s), the generative design engine 152 can create one or more obstacle bodies that prevent the generative design algorithm from applying material at the particular areas along or near the edge.

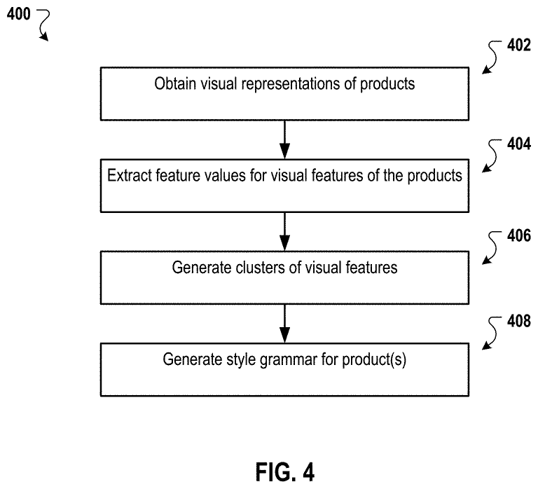

The style grammar generation engine 156 can generate style grammars for a product or group of products based on visual representations of the product(s) and optionally visual representations of other products, e.g., similar products offered by other manufacturers. The visual representations of the products can include images of the products and/or CAD files or CAD models of the products. The images and/or CAD files can be stored in a product images database 168 or other appropriate data structure. Example processes for generating style grammars are described with reference to FIGS. 4 & 5.

The inputs to the generative design process can also include physical constraints on the product. The physical constraints for products and/or types of products can be stored in a constraints database 166 or other appropriate data structure. In general, the physical constraints are related to the physical properties and/or required performance of the product. The types of physical constraints can vary based on the type of product and/or how the product will be used. For example, the physical constraint of a wheel may be to support a minimum weight and be within a particular size range. If the wheel is for a compact car, the weight requirement and size would be different from the weight requirement of a wheel for a work truck. A physical constraint on an engine part may be a minimum temperature tolerance.

The generative design process can also include additional user customizable inputs based on the product or use for the product. For example, if the product is going to be used as part of another product, e.g., a rim for a vehicle, the inputs can include information about the other product, e.g., a vehicle profile for the car, a driver profile for a driver of the vehicle. The vehicle profile can indicate various characteristics of the vehicle, such as the length, width, weight, maximum speed, maximum acceleration, etc. The driver profile can include data related to the way the user drives, e.g., average speed, speed at which the driver takes turns, acceleration, deceleration, etc. This information can be obtained from a set of sensors in communication with the client computing device 110 or the generative design platform 150. For example, an accelerometer of a mobile device or of the vehicle can provide acceleration data for a test drive or normal drive for the user.

The user interfaces 114 can enable the user to customize other characteristics of the product for input to the generative design process. For example, a product template can have one or more customizable characteristics. In a particular example, a product template for a shirt can include, as customizable characteristics, sleeve length, collar type, whether there are buttons and how far down the shirt, etc. In a car rim example, the customizable characteristics can include spoke type, style (e.g., racing, sport, off-road, standard, heavy duty, etc.), color, and/or finish.

The generative design engine 152 can perform a generative design process to generate candidate product designs based at least in part on the inputs. This can include varying a set of characteristics of the product and evaluating the product design to determine whether the resultant product design satisfies the stylistic and physical constraints for the product. The constraints and the obstacle bodies force the generative design process to generate product designs having aesthetics and performance that meets those constraints. Continuing the car rim example, this can include varying the hub offset (e.g., positive, negative, or neutral), the spoke base material, the spoke pattern and size, the number of spokes, and/or the proportion slice of the wheel. The characteristics that are varied in the generative design process can be based on the type of product and can be maintained by the generative design platform 150. In some implementations, these characteristics can be selected by the user and/or defined by the style grammar. For example, a style grammar may specify that a rim includes a particular number of spokes, that there is a minimum spacing between spokes, or that the rim include a particular style of spokes.

The design evaluation engine 154 evaluates each candidate product for one or more objectives and outputs a score for each objective based on the evaluation. One objective is conforming to the stylistic parameters of the style grammar(s) for the product design. In this evaluation, the design evaluation engine 154 can compare the visual characteristics of a candidate product design to each parameter of the style grammar. For example, if the style grammar includes, as a parameter, a range of shades of a color for a part of the product, the design evaluation engine 154 can compare the color of the part of the product to this color range and generate a score that indicates how well the color of the product matches or falls within the color range. A candidate product design with a color outside of the range would have a lower score (indicating lower conformity) than a candidate product design that is within the color range.

In another example, the design evaluation engine 154 an compare the radii of curves of the candidate design to the radii specified by a parameter of the style grammar. The score for this parameter can be based on how close the radii of the curves of the candidate product design are to the specified radii, e.g., the score can be higher the closer the radii are to the specified radii.

The design evaluation engine 154 can generate a style score based on the individual scores for the various parameters defined by each style grammar that is used as an input to the generative design process. The design evaluation engine 154 can combine the individual scores, with optional weights based on the importance of the parameter, to generate the style score. For example, the design evaluation engine 154 can determine an average, e.g., a weighted average, of the individual scores.

Another objective is a performance objective. There can be multiple performance objectives for a product. For example, the performance objectives for a cooler can be to maintain temperature and carry a minimum number or range in the number of products that can be stored in the cooler. For each performance objective, the design evaluation engine 154 can include a set of rules, models, or algorithms that the design evaluation engine 154 can apply to the product designs to determine the physical performance of the product design for each objective. An example rule may indicate that a particular material can sustain temperature within a particular range. A model can use the physical properties of materials and amounts of force placed on the spokes of a rim in various configurations, among other physical characteristics of a rim. Such a model can be used to determine the maximum weight of a vehicle that various designs of a rim can sustain. The design evaluation engine 154 can evaluate the candidate designs for each performance objective and generate a score for each performance objective based on the evaluation. Similar, to the style score, the individual scores can be weighted and combined for a total performance score or each performance score can be used in the candidate product design selection process and/or displayed to the user.

Another objective is a manufacturability objective. Such an objective can be used to determine whether the product design can be manufactured using a given manufacturing process and/or how well the product can be produced using the given manufacturing process. For example, many products can be manufactured using multiple different process. In a particular example, a plastic bottle can be manufactured using injection molding or blow molding. However, some may be more suitable for a product than others, e.g., depending on the shape and/or size of a plastic bottle. The design evaluation engine 154 can use a set of rules, models, or algorithms to determine, based on characteristics of a candidate product design, a measure of how manufacturable a product is using a given manufacturing process. For each given manufacturing process for a type of product, the design evaluation engine 154 can evaluate the characteristics of a candidate product design and generate a manufacturability score that represents a measure of manufacturability of the product using the given manufacturing process.

The design evaluation engine 155 can combine two or more of the scores, e.g., the style score, the performance score(s), and the manufacturability score for a specified manufacturing process to generate an overall score for each candidate product design. The overall score can be a weighted average of the scores using weights corresponding to the importance of each score.

The generative design engine 152 can select a subset of the candidate product designs based on the overall scores for the candidate product designs and provide information about these candidate product designs to the client-side application 112 for display to the user. The information can include the visual representation of each candidate product design, the overall score for each candidate product design, and/or the individual scores that are used to determine the overall score, e.g., the style score, the performance score(s), and/or the manufacturability score.

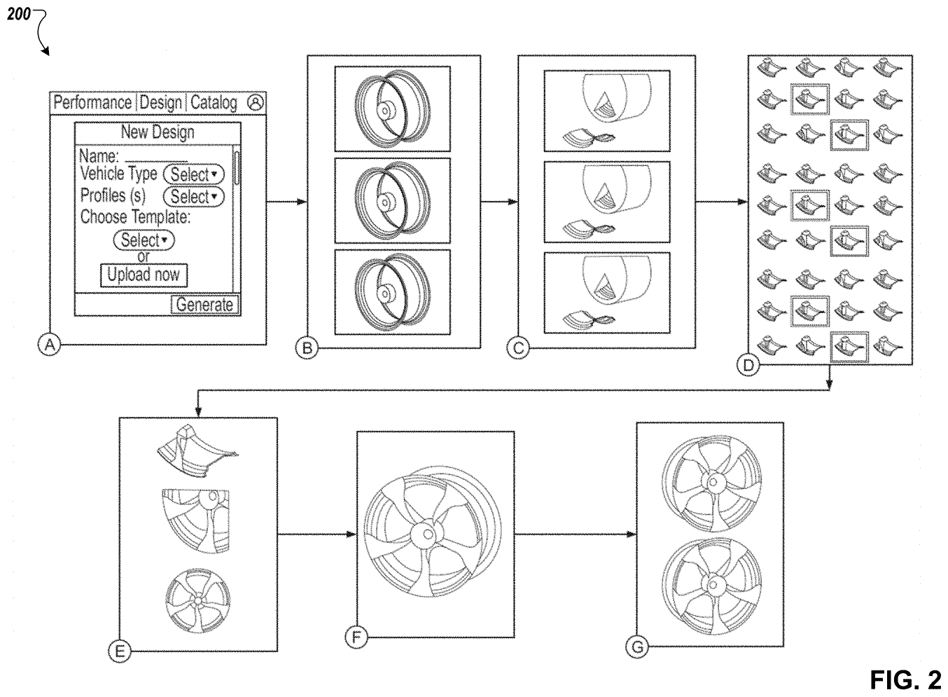

FIG. 2 shows an example process 200 for generating product designs using a style grammar. In this example, the generative design platform 150 generates multiple product designs for a rim for a vehicle. In stage A, the generative design platform 150 receives data identifying a set of design parameters. The set of design inputs can be selected by a user using a client-side application 112. As described above, the inputs can include a selection of a product temple, a selection of one or more style grammars, and/or user-customizable inputs. The client-side application 112 can provide data identifying the user's selections to the generative design platform.

In stage B, the generative design platform 150 programmatically generates multiple design templates and obstacle bodies. The generative design platform 150 can generate the design templates based on the input data received from the user. Each design template can be a candidate product design, e.g., a candidate rim design. The generative design platform 150 generates each candidate product design by varying characteristics of the rim design, e.g., by varying the characteristics of the input rim template in ways that conform to the various stylistic constraints defined by the style grammar(s) and physical constraints for the rim. For example, the generative design platform 150 can vary the hub offset, the spoke base material, the spoke pattern, the spoke size, the number of spokes, and/or the proportion slice of the wheel. Each adjustment should conform to the stylistic and physical constraints and should not intrude on any obstacle bodies. In this example, three candidate rim designs are shown but many more are possible at this stage.

In stage C, the generative design platform 150 applies various design parameters, such as obstacles and forces. In some cases, the obstacle body can be in the form of an inverse of a rim design. The generative design platform 150 can apply the obstacle bodies at this stage to prevent the addition of material to the candidate rim designs in areas where material cannot be added, e.g., for brand aesthetic and/or functional purposes.

In stage D, the generative design platform 150 runs the generative design process and automatically selects the best, e.g., highest scoring designs. For example, as described above, the generative design platform 150 can iteratively generate multiple candidate product designs using the template(s), the style grammar(s), obstacle bodies, and other constraints, and evaluate each candidate product design based on style, performance, and/or manufacturability. The generative design platform 150 can also generate one or more scores. In this example, the style score can be based on the visual characteristics of the individual spokes, the number of spokes, the spacing between spokes, visual characteristics of the lug holes, visual characteristics of the center bore, the curvature of each edge of the rim, and/or other visual characteristics having a corresponding style parameter defined by the style grammar(s). The generative design platform 150 can select the candidate rim designs having the highest scores.

In stage E, the generative design platform 150 can revolve, process, and cleanup the selected candidate rim designs. This can include refining the geometric shapes of the rim design based on manufacturing specifications, style grammar constraints, manufacturability, etc. In general, this stage can finalize each candidate rim design such that the design is ready for manufacturing if selected by the user as a final design choice. For example, this stage can generate a complete and usable product from the generatively designed product. This can include manual refinement in some cases. In the illustrated example, this stage can include taking the portion of the rim generatively designed in the previous stages and generating a complete wheel. For example, a user may identify a preferred candidate product design, but want to redesign it or change some fillets to be manufacturable with a different method. The generative design platform 150 can provide user interface controls that enable users to make manual modifications to the product designs.

In stage F, the generative design platform 150 evaluates the selected candidate rim designs for an overall design, performance, and brand consistency. In this stage, an entire product design of the product can be evaluated more thoroughly than the evaluations in stage D. For example, in stage D, a part of the wheel, e.g., the rim, can be evaluated to generatively design a rim as a subcomponent of a wheel. In stage F, a selected rim design can be evaluated as part of a completed wheel, e.g., after any refinements to the overall design have been incorporated into the wheel. This evaluation can be more comprehensive and more accurate than the evaluations performed in stage D.

In stage G, the selected candidate designs are displayed to the user. The user interface 114 of the client-side application 112 can display a visual representation of each selected candidate rim design and optionally the score(s) used to select the candidate rim designs that are displayed to the user.

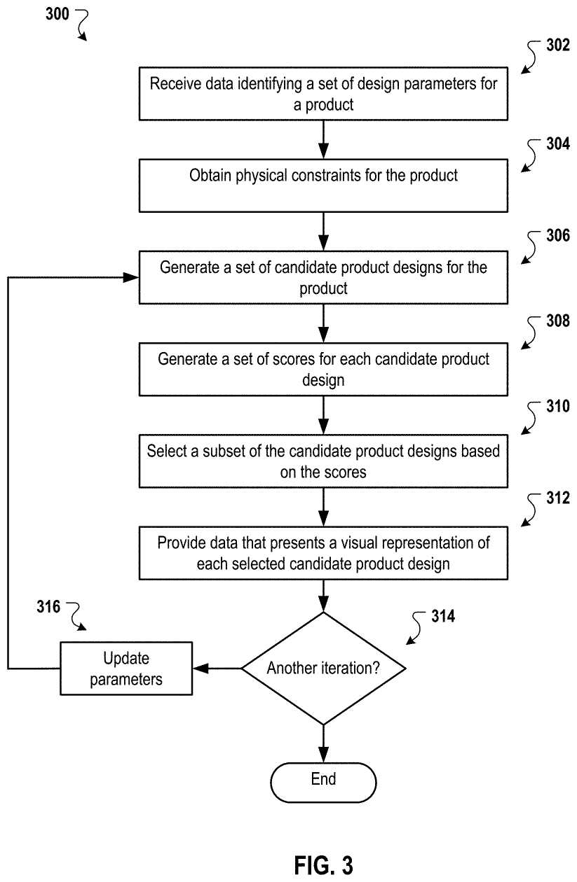

FIG. 3 is a flow diagram of an example process 300 for generating products designs using style grammars. The process 300 can be performed, for example, by the generative design platform 150 of FIG. 1, which can be implemented as a system of one or more computers. Operations of the process 300 can also be implemented as instructions stored on one or more computer readable media which may be non-transitory, and execution of the instructions by one or more data processing apparatus can cause the one or more data processing apparatus to perform the operations of the process 300. For brevity, the process 300 is described as being performed by the generative design platform 150.

The generative design platform 150 receives data identifying a set of design parameters for a product (302). The design parameters can include a product template for the product and one or more style grammars. The user can select, from a set of product templates, a particular product template for use in generating multiple candidate product designs. The user can also select, from a set of style grammars one or more styles grammars for generating the candidate product designs. For example, the user can select a style grammar for an overall brand and one or more style grammars for product types or sub-brands within the brand. In a particular example, the product can be a shoe and the user can select a style grammar for an athletic apparel brand. The user can also select a style grammar for a particular sport, e.g., basketball, and/or for a particular sub-brand within the overall athletic apparel brand, e.g., a sub-brand for outdoors enthusiasts. Each style grammar can include a set of stylistic parameters that define aesthetic characteristics of a group of products within the brand, sub-brand, or type of products.

Advantageously, a user can select a style grammar for a different type of product than the one for which candidate product designs are being generated, or for no particular product at all. For example, the style grammar for a brand may not be product specific and can instead include parameters extracted from different types of products within the brand. This enables the user and the generative design platform 150 to collaborate on the design of other types of products that conform to the style of the brand. In addition, this enables the generative design platform 150 to apply the styles of one type of product to a different type of product, which makes it faster and more efficient to design one-off products that that are different from other products manufactured by the company.

The user can also provide, as input, additional preferences that can be used in the generative design process. These additional preferences can be functional and/or stylistic. For example, as described above, a user can provide a driver profile that can be used in designing rims or other parts of a vehicle that satisfy the functional demands for that driver. In another example, the user can specify preferred color schemes, logo size or placement, and/or other visual preferences for the product. The user's visual preferences can also be determined, for example, by collecting data on the most popular product designs sold, selecting product designs that look most like the user's past designs, and/or using an individual's selections of past product designs that the user preferred. The user's visual preferences can be determined using conjoint analysis, sentiment analysis, and/or genetic algorithms.

The generative design platform 150 obtains, for the product, one or more physical constrains on a design of the product (304). The physical constraints for products and/or types of products can be stored in a constraints database 166 or other appropriate data structure. As described above, the physical constraints are related to the physical properties and/or required performance of the product.

The generative design platform 150 generates a set of candidate product designs for the product (306). As described above, the generative design platform 150 can generate the candidate product designs by varying a set of characteristics of the product template in accordance with the stylistic constraints, physical constraints, and any obstacle bodies defined by (or generated based on) the style grammar(s) and physical constraints.

The generative design platform 150 generates a set of scores for each candidate product design (308). The scores can include a style score that represents a measure of how well the candidate product design conforms to the aesthetic characteristics of each style grammar. To determine the style score, the generative design platform 150 can compare the visual characteristics of a candidate product design to each parameter of the style grammar. For example, if the style grammar includes, as a parameter, a range of shades of a color for a part of the product, the design evaluation engine 154 can compare the color of the part of the product to this color range and generate a score that indicates how well the color of the product matches or falls within the color range. A candidate product design with a color outside of the range would have a lower score (indicating lower conformity) than a candidate product design that is within the color range.

The scores can also include a performance score and/or a manufacturability score. The performance score represents a measure of how well the candidate product design satisfies one or more performance objectives for the product. The manufacturability score represents a measure of manufacturability of the product using a specified manufacturing process.

The scores can also include a design cost. The design cost for a candidate product design can be an estimate of the cost to manufacture the product using the candidate product design. The generative design platform 150 can estimate the design cost based on, for example, the materials used in the product design, the amount of each material required, the manufacturing process that will be used to manufacture the product, and/or other appropriate factors.

Although only one iteration of steps 306 and 308 are illustrated in FIG. 3, the generative design platform 150 can perform multiple iterations of these two steps prior to moving to step 310. For example, the generative design platform 150 can generate multiple product designs and evaluate the product designs until converging on a set of candidate designs for which information is presented to the user. Convergence can be met when it is determined that changing the characteristics of the candidate product designs do not result in a significant, e.g., at least a threshold, change in the scores between successive iterations. Other convergence conditions can also be used.

The generative design platform 150 selects, based on the set of scores for each candidate product design, a subset of the candidate product designs (310). The subset can be a proper subset which includes fewer than all members of the set, or the entire set of candidate product designs. In some implementations, the generative design platform 150 generates an overall score for each candidate product design based on the set of scores for the candidate product design. The generative design platform 150 can then select a specified number of the candidate product designs based on the overall scores. For example, the generative design platform 150 can select a specified number of candidate product designs having the highest overall scores.

The generative design platform 150 provides, to a client computing device, data that causes the client computing device to present a visual representation, e.g., computer-generated image, of each selected candidate product design. For example, the generative design platform 150 can provide, to the client computing device, data that instructs a client-side application to update a user interface to present the visual representation of each selected candidate product design. The data can also cause the client-side application to present the scores for each selected candidate product design, e.g., the overall scores, the style scores, the performance scores, the manufacturability score, and/or the design cost.

The generative design platform 150 determines whether to perform another iteration of the generative design process (314). The generative design platform 150 can perform another iteration in response to the user selecting some of the candidate product designs displayed to the user by the client-side application. Or, if the user selects one of the candidate product designs as a final product design, the process 300 can end. The product design can then be used as the basis for manufacturing the product. For example, the product design can be sent to a product lifecycle management (PLM) tool for final costing and manufacturing.

If another iteration is performed, the generative design platform 150 can update the parameters of the generative design process based on the user's selection of candidate product designs (316). For example, the generative design platform 150 can evaluate characteristics of the selected candidate product designs and characteristics of the non-selected candidate product designs. In this evaluation, the generative design platform 150 can identify similarities between the selected candidate product designs, e.g., similarities in visual characteristics such as color, curve radii, number of spokes (if the product is a rim), etc. The generative design platform 150 can identify similarities in scores, e.g., if the user selected product designs having high style scores but low manufacturability scores, it indicates that the user considers style more important than manufacturability.

The generative design platform 150 can also identify differences between the selected candidate product designs and the non-selected candidate product designs. For example, the generative design platform 150 can identify differences in visual characteristics of the selected candidate product designs and the non-selected candidate product designs.

The generative design platform 150 can update the parameters, for example, by adjusting weights associated with the similar characteristics and the different characteristics. For example, For example, if the user selects candidate product designs that better conform with the color parameter defined by a style grammar, the generative design platform 150 can increase the weight for that parameter. The generative design platform 150 can also adjust the scoring process to increase the scores for product designs having the characteristics that are similar between the selected candidate product designs. The generative design platform 150 can also reduce the scores for candidate product designs that have the characteristics that are identified as being different from the selected candidate product designs. In some implementations, the user can also specify, using a user interface of the client-side application, visual characteristics of candidate product designs that user wants the next set of candidate product designs to include.

After updating the parameters, the generative design platform 150 performs steps 306 to 312 for another iteration of the generative design process. The generative design platform 150 can repeat these steps for multiple iterations until the user selects a final product design for the product.

FIG. 4 is a flow diagram of an example process 400 for generating a style grammar for a product or group of related products. The process 400 can be performed, for example, by the generative design platform 150 of FIG. 1, which can be implemented as a system of one or more computers. Operations of the process 400 can also be implemented as instructions stored on one or more computer readable media which may be non-transitory, and execution of the instructions by one or more data processing apparatus can cause the one or more data processing apparatus to perform the operations of the process 400. For brevity, the process 400 is described as being performed by the generative design platform 150.

The generative design platform 150 obtains visual representations of products (402). The visual representations can include images of the products, CAD files or models that represent the products, and/or other visual representations of the products.

When generating a style grammar for a type of product, the generative design platform 150 can obtain visual representations from one or more particular perspectives, e.g., from a set of viewing angles. When determining the style of a product or group of products, what matters is not the overall three-dimensional geometry of the product, but rather the way the object is perceived by humans. For example, a chair is meant to be viewed primarily from a standing height of a human and from multiple perspectives around the chair.

To properly extract certain features, multiple perspectives can be used. For example, the curvature of the headlights or front edges of a car may be best extracted from both a direct front view of the car and diagonal views from the front and either side of the car. In this example, the generative design platform 150 can select images from all three perspectives for extracting the radii and other properties of the curvature of these portions of a car. In addition, the generative design platform 150 can extract images captured from different heights based on the different heights of humans. In this way, the images used to generate the style grammar depict the features of the product from the various perspectives of humans that will view, use, or otherwise interact with the product.

The generative design platform 150 can maintain a list of perspectives for each type of product. When generating a style grammar for a particular type of product, the generative design platform 150 can obtain the list of perspectives and use the list to select images or other visual representations for use in generating the style grammar. For example, the generative design platform 150 can select images that match the perspectives in the list and discard, or ignore, images that are from different perspectives that are not on the list. In another example, the generative design platform 150 can use the list to control a camera to capture images of a product from the appropriate perspectives.

In some implementations, the generative design platform 150 can use machine learning techniques to classify the perspective for each image of a product in a set of images. The generative design platform 150 can use the classifications to select the images for use in generating the style grammar for the product(s). Similarly, CAD files can be labeled based on the viewing angle for the product represented by the CAD file. The generative design platform 150 can use the labels to select the images for use in generating the style grammar. Although other types of visual representations can be used, the remaining description of the process 500 is in terms of images for brevity.

Depending on how the style grammar is generated, the generative design platform 150 can obtain images of a particular product of a particular brand (or other group of related products), images of multiple products of the particular brand, and/or images of products of multiple different brands. For example, the generative design platform 150 can generate a style grammar for a particular product using only images of the particular product. In another example, the generative design platform 150 can generate a style grammar for a particular product based on images of the particular product and images of other products within the same brand and/or images of the same type of product of another brand, e.g., of a competitor brand. In yet another example, the generative design platform 150 can generate a style grammar for a group of related products, e.g., for a brand that has multiple types of products, using images of products in the brand and optionally images of the same types of products of other brands. For example, the generative design platform 150 can generate a style grammar for a group of electronic products that include smartphones, tablet computers, laptop computers, and wearables using images of these devices and images of similar devices offered or manufactured by a different entity.

In some implementations, the images can include images of a particular product or group of products over a given time period or images of multiple versions of the product. In this way, the generative design platform 150 can consider which visual characteristics have remained constant or similar over time and therefore may be important to the brand identity, and which visual characteristics have varied over time and therefore may be less important to the brand identity. This also enables the generative design platform 150 to identify visual characteristics that are important to recent product designs and visual characteristics that may no longer be important.

Similarly, the generative design platform 150 can use images of different versions of a product to identify the visual characteristics that are important for each version. For example, the visual characteristics of a base design of a product can differ from the top of the line version of the product. In this example, the generative design platform 150 can obtain and use images of each version of the product.

The generative design platform 150 extracts, from the images, feature values for visual features in the images. The generative design platform 150 can use various feature extraction techniques, such as edge detection, color detection, object detection, object recognition, computer vision analysis, and/or other techniques to extract the feature values for the visual features. The visual features can include, for example, the size of a logo, the position of the logo on the product, color(s) of the product, materials of the product or each part of the product, the finish of the product or each part of the product, how curves are treated, e.g., the curvature comb, how transitions between curves are handled, corner radii, and relative proportion between parts of subcomponents. The feature values are parameters that represent the actual visual characteristics extracted for these features. For example, the feature value for a color can be the red-green-blue (RGB) value for a detected color in an image.

The generative design platform 150 can maintain a list of features for extraction for each type of product. For example, some features may be important for some types of products and unimportant for other types of products. The generative design platform 150 can obtain the list for the type of product(s) for which the style grammar is being generated and use the list to determine the feature values for the appropriate features using the images.

The generative design platform 150 can assign a label to each feature value. The label for a feature value can identify the product corresponding to the image from which the feature value was extracted and the visual feature corresponding to the feature value. For example, a label for the distance between headlights can indicate “headlight distance” and the year, make, model, and/or trim of the car. The label can also optionally indicate the perspective from which the image was captured.

The generative design platform 150 clusters the feature values for the visual features (406). The generative design platform 150 can generate clusters that represent visually similar features. The generative design platform 150 can use clustering techniques, e.g., machine learning clustering techniques, that identify similar features and place the labeled feature values in clusters with other similar feature values. There can be one or more clusters for each visual feature. An example feature is the curvature of a corner of a table. One cluster can include curves for tables having corners with a first range of radii and another cluster can include curves for tables having corners with a second range of radii. For the same tables, there can be clusters for different ranges of surface colors, finishes, and/or other features.

The generative design platform 150 uses the clusters to generate the style grammar for the product or group of products (408). The generative design platform 150 can use the clusters to identify the visual features to include in the style grammar, e.g., the features considered important for the aesthetic characteristics of a brand or other group of related products, and to determine the parameters for the visual features in the style grammar, e.g., the acceptable range and/or the target value for use in scoring candidate product designs. The clusters and the ways that the clusters are used for generating the style grammar can differ based on the images used for feature extraction, e.g., based on whether images of other products and/or images for different versions of the product(s) are used.

In either case, the generative design platform 150 can evaluate how tightly clustered, e.g., how similar, the feature values are for a visual feature of the product or group of products. For example, if the radii of the edges are all within a small range and therefore in a tightly packed cluster (e.g., with the feature values being within a short distance from the average for the cluster), this range of radii may be an important visual characteristic of the product(s). In response, the generative design platform 150 can include this feature in the style grammar. In addition, the generative design platform 150 can designate the feature as an important feature with a correspondingly higher weight than a less important feature.

As part of the style grammar, the generative design platform 150 can also define a more narrow range of acceptable values for the feature based on the narrow range extracted from the images of the product. This range can be selected to extend from the smallest radii of the product or group of products found in the tightly packed cluster. If radii of the product or group of products are found in other clusters as well, the range can be adapted to exclude those radii, e.g., as those radii may be outliers as compared to the radii in the tightly packed cluster.

In contrast, if the radii of the edges vary significantly resulting in loose clusters (e.g., with the feature values of the cluster having a large distance from the average for the cluster) or the radii for the product being in multiple clusters, this feature may be less important. Thus, the generative design platform 150 can determine to not include this feature in the style grammar or set a wider range for the visual feature in the style grammar corresponding to the wide range extracted from the images.

For example, the generative design platform 150 can evaluate the quantity of feature values for a particular feature found in each cluster. If all of the feature values are found in the same cluster, that feature can be considered important and be used in the style grammar. If the feature values are scattered between different clusters and no cluster has significantly more feature values of the product(s) than any other cluster, the feature may not be considered important.

The generative design platform 150 can consider, for a feature of a product, the number of clusters that include feature values for that feature and/or the average distance from a cluster average for the members of the cluster. In another example, the generative design platform 150 can consider the similarity of the feature values for the feature, e.g., the standard deviation between the feature values. The generative design platform 150 can use this information to determine whether to include the feature in the style grammar, how wide the range of values for the feature should be in the style grammar (an therefore how much freedom the generative design platform 150 has to adjust that feature when generating candidate product designs), and/or the weight of the feature when generating the style score for the candidate product designs.

When images of products of other brands or other groups or products are used, the generative design platform 150 can evaluate the similarities and differences between the feature values for the product(s) for which the style grammar is being generated and the other products. If the feature values for a particular feature are similar across all of the products (e.g., all in the same cluster), that feature may be considered less important for brand identity and either excluded from the style grammar or given a wide range of values for the generative design process to consider. If the feature values for a particular feature are similar for the product(s) for which the style grammar is being generated (e.g., all within the same cluster) and these feature values are significantly different from the feature values of the other products (e.g., the feature values for the other products are in different clusters), this feature may be important and included in the style grammar with a narrower range of values for the generative design process to consider.

When images of different version of the product(s) are used, the generative design platform 150 can evaluate how similar the feature values are for a feature across multiple versions and/or for recent versions as compared to older versions. In some examples, the generative design platform 150 can evaluate, for a feature, the number of versions for which the feature values are clustered together. If more versions are clustered together, the feature can be considered more important than if fewer versions are clustered together. If recent versions are clustered together while older versions are spread out among multiple clusters, the feature can be considered an important visual feature of the new designs.

The generative design platform 150 can determine the range of feature values for a parameter of the style grammar and/or the weight for the parameter based on the clustering, e.g., based on a measure of importance for the feature corresponding to the parameter determined based on the clustering. The range of values can narrow with an increase in importance. As the feature is considered important to the style of the product, the narrower range can force the generative design process to stay within a strict range. If the feature is not as important, a wider range gives the generative design process more freedom to vary the visual characteristic without departing from the brand's style.

Similarly, the weight assigned to a parameter can increase with an increase in importance. The generative design platform 150 can use the weight to determine the style score for the candidate product designs generated using the generative design process. For example, the generative design process 150 can determine, for a feature, a score based on how well the feature conforms to the aesthetic characteristics defined by the style grammar. The generative design platform can then multiply the score by the weight for that feature and aggregate the products for an overall style score for the candidate product design. The generative design platform 150 can store the style grammar in the database 164

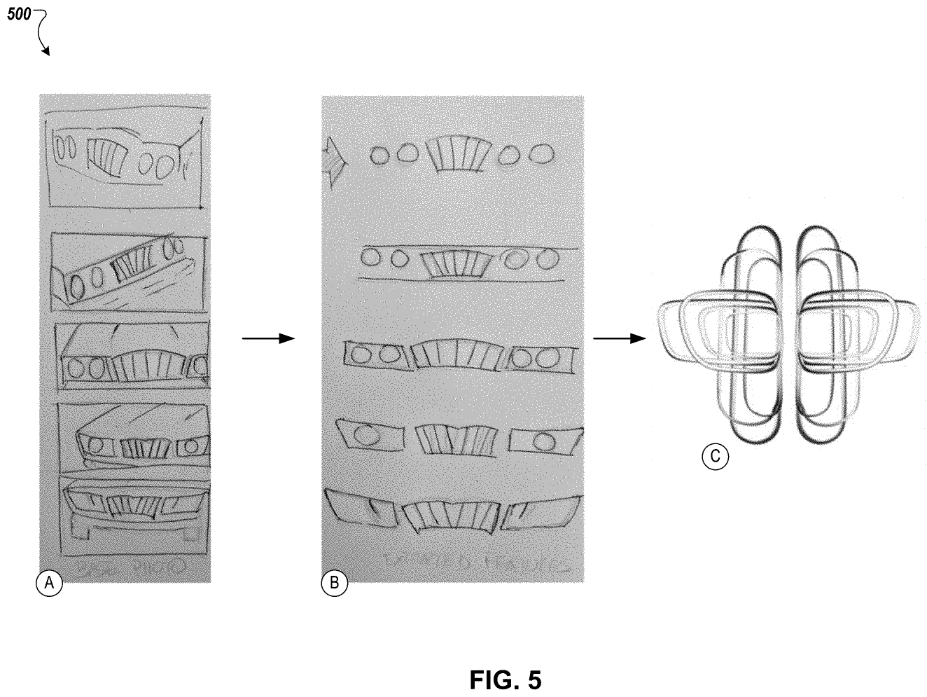

FIG. 5 shows a process 500 for generating a style grammar. In this example, the generative design platform 150 generates a style grammar for the grill and headlights of a car.

In stage A, the generative design platform 150 obtains a set of images of the car. In particular, the generative design platform 150 can obtain images from multiple perspectives from in front of the car. As shown in FIG. 5, some of the images are from angled views, some of the images are from directly in front of the car, and the height from which some of the images were captured are higher than others. By using multiple perspectives, the generative design platform 150 can extract feature values for features from the different angles at which a person may view the car.

In stage B, the generative design platform 150 extracts, from the images, feature values for the visual features of the car. The features can include, for example, the relative positions of the headlights and grill (e.g., the spacing between each pair of components, the relative sizes of the components, the shapes of the components, the colors of the components, etc.

In stage C, the generative design platform 150 generates a style grammar based on the extracted feature values for the features. As described with reference to FIG. 4, clustering and feature similarity can be used to generate the style grammar. In this example, the style grammar can specify parameters (e.g., acceptable ranges) for the size and shape of the grill and headlights, the spacing between these components, the relative sizes of the components, etc.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the user device, which acts as a client. Data generated at the user device, e.g., a result of the user interaction, can be received from the user device at the server.

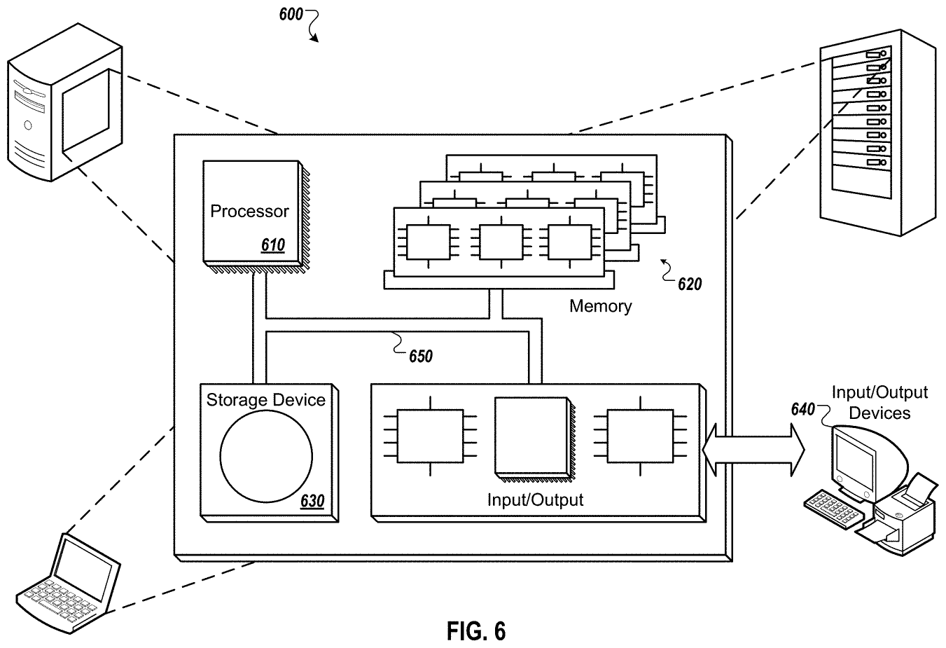

An example of one such type of computer is shown in FIG. 6, which shows a schematic diagram of a computer system 600. The system 600 can be used for the operations described in association with any of the computer-implemented methods described previously, according to one implementation. The system 600 includes a processor 610, a memory 620, a storage device 630, and an input/output device 640. Each of the components 610, 620, 630, and 640 are interconnected using a system bus 650. The processor 610 is capable of processing instructions for execution within the system 600. In one implementation, the processor 610 is a single-threaded processor. In another implementation, the processor 610 is a multi-threaded processor. The processor 610 is capable of processing instructions stored in the memory 620 or on the storage device 630 to display graphical information for a user interface on the input/output device 640.

The memory 620 stores information within the system 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the system 600. In one implementation, the storage device 630 is a computer-readable medium. In various different implementations, the storage device 630 may be a floppy disk device, a hard disk device, an optical disk device, or a tape device.

The input/output device 640 provides input/output operations for the system 600. In one implementation, the input/output device 640 includes a keyboard and/or pointing device. In another implementation, the input/output device 640 includes a display unit for displaying graphical user interfaces.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more data processing apparatus, the method comprising:
for each product of a plurality of products,
obtaining one or more visual representations of the product, and
extracting, from the one or more visual representations of the product, feature values for visual features of the product;
generating, for each visual feature of a set of visual features, one or more clusters that each include a set of feature values for one or more of the plurality of products classified as being similar feature values;
generating, for a group of related products, a style grammar based on the set of feature values assigned to each cluster, wherein the style grammar for the group of related products comprises a set of stylistic parameters that specify respective ranges of feature values for visual features that represent aesthetic characteristics of the group of related products;
performing a generative design process using the generated style grammar to generate multiple candidate product designs for a given product of the group of related products; and
providing, to a client computing device, data that causes the client computing device to present a visual representation of one or more of the multiple candidate product designs.

2. The method of claim 1, wherein obtaining the one or more visualization representations of each product comprises:
obtaining a set of images of the product;
identifying a given type of the product;
identifying a specified perspective for images that are used for generating style grammars for products of the given type; and
selecting, as the one or more visual representations of the product, one or more images captured from the specified perspective.

3. The method of claim 1, further comprising:
receiving, from a client computing device of a user, data identifying a set of design parameters comprising a product template for the given product and the generated style grammar;
obtaining, for the given product, one or more physical constraints on a design of the given product;
generating, by evaluating each candidate product design, a set of scores for each candidate product design, the set of scores including a style score representing a measure of how well the candidate product design conforms to ranges of visual features that represent the aesthetic characteristics of the generated style grammar and a performance score representing a measure of how well the candidate product design satisfies one or more performance objectives for the given product, wherein the candidate product designs are generated based on the generated style grammar, the product template, and the one or more physical constraints; and
selecting, based on the set of scores for each candidate product design, the one or more candidate product designs.

4. The method of claim 1, wherein generating the set of clusters comprises, for each visual feature of the set of visual features, generating one or more clusters that each includes feature values for the group of related products.

5. The method of claim 4, wherein generating, for the group of related products, the style grammar based on the set of visual features assigned to each cluster comprises:
determining, for each given visual feature of the group of related products, a measure of importance of the given visual feature based on the feature values assigned to each cluster; and
assigning a weight to each given visual feature based on the determined measure of importance for the given visual feature.

6. The method of claim 5, further comprising:
for each candidate product design, determining, based on a feature value for each given visual feature of the candidate design and the weight assigned to each given visual feature, a score for the candidate design; and
selecting the one or more of the candidate designs based on the score for each candidate design.

7. The method of claim 1, wherein generating, for a group of related products, the style grammar based on the set of feature values assigned to each cluster comprises identifying, for a given visual feature, the range of the feature values for the group of related products assigned to a same cluster.

8. A computer-implemented system, comprising:
one or more computers; and
one or more computer memory devices interoperably coupled with the one or more computers and having tangible, non-transitory, machine-readable media storing one or more instructions that, when executed by the one or more computers, perform operations comprising:
for each product of a plurality of products,
obtaining one or more visual representations of the product, and
extracting, from the one or more visual representations of the product,
feature values for visual features of the product;
generating, for each visual feature of a set of visual features, one or more clusters that each include a set of feature values for one or more of the plurality of products classified as being similar feature values;
generating, for a group of related products, a style grammar based on the set of feature values assigned to each cluster, wherein the style grammar for the group of related products comprises a set of stylistic parameters that specify respective ranges of feature values for visual features that represent aesthetic characteristics of the group of related products;
performing a generative design process using the generated style grammar to generate multiple candidate product designs for a given product of the group of related products; and
providing, to a client computing device, data that causes the client computing device to present a visual representation of one or more of the multiple candidate product designs.

9. The computer-implemented system of claim 8, wherein obtaining the one or more visualization representations of each product comprises:
obtaining a set of images of the product;
identifying a given type of the product;
identifying a specified perspective for images that are used for generating style grammars for products of the given type; and
selecting, as the one or more visual representations of the product, one or more images captured from the specified perspective.

10. The computer-implemented system of claim 8, wherein the operations comprise:
receiving, from a client computing device of a user, data identifying a set of design parameters comprising a product template for the given product and the generated style grammar;
obtaining, for the given product, one or more physical constraints on a design of the given product;
generating, by evaluating each candidate product design, a set of scores for each candidate product design, the set of scores including a style score representing a measure of how well the candidate product design conforms to ranges of visual features that represent the aesthetic characteristics of the generated style grammar and a performance score representing a measure of how well the candidate product design satisfies one or more performance objectives for the given product, wherein the candidate product designs are generated based on the generated style grammar, the product template, and the one or more physical constraints; and
selecting, based on the set of scores for each candidate product design, the one or more candidate product designs.

11. The computer-implemented system of claim 8, wherein generating the set of clusters comprises, for each visual feature of the set of visual features, generating one or more clusters that each includes feature values for the group of related products.

12. The computer-implemented system of claim 11, wherein generating, for the group of related products, the style grammar based on the set of visual features assigned to each cluster comprises:
determining, for each given visual feature of the group of related products, a measure of importance of the given visual feature based on the feature values assigned to each cluster; and
assigning a weight to each given visual feature based on the determined measure of importance for the given visual feature.

13. The computer-implemented system of claim 12, wherein the operations comprise:
for each candidate product design, determining, based on a feature value for each given visual feature of the candidate design and the weight assigned to each given visual feature, a score for the candidate design; and
selecting the one or more of the candidate designs based on the score for each candidate design.

14. The computer-implemented system of claim 8, wherein generating, for a group of related products, the style grammar based on the set of feature values assigned to each cluster comprises identifying, for a given visual feature, the range of the feature values for the group of related products assigned to a same cluster.

15. A non-transitory, computer-readable medium storing one or more instructions that, when executed by a computer system, cause the computer system to perform operations comprising:
for each product of a plurality of products,
obtaining one or more visual representations of the product, and
extracting, from the one or more visual representations of the product, feature values for visual features of the product;
generating, for each visual feature of a set of visual features, one or more clusters that each include a set of feature values for one or more of the plurality of products classified as being similar feature values;
generating, for a group of related products, a style grammar based on the set of feature values assigned to each cluster, wherein the style grammar for the group of related products comprises a set of stylistic parameters that specify respective ranges of feature values for visual features that represent aesthetic characteristics of the group of related products;
performing a generative design process using the generated style grammar to generate multiple candidate product designs for a given product of the group of related products; and
providing, to a client computing device, data that causes the client computing device to present a visual representation of one or more of the multiple candidate product designs.

16. The non-transitory, computer-readable medium of claim 15, wherein obtaining the one or more visualization representations of each product comprises:
obtaining a set of images of the product;
identifying a given type of the product;
identifying a specified perspective for images that are used for generating style grammars for products of the given type; and
selecting, as the one or more visual representations of the product, one or more images captured from the specified perspective.

17. The non-transitory, computer-readable medium of claim 15, wherein the operations comprise:
receiving, from a client computing device of a user, data identifying a set of design parameters comprising a product template for the given product and the generated style grammar;
obtaining, for the given product, one or more physical constraints on a design of the given product;
generating, by evaluating each candidate product design, a set of scores for each candidate product design, the set of scores including a style score representing a measure of how well the candidate product design conforms to ranges of visual features that represent the aesthetic characteristics of the generated style grammar and a performance score representing a measure of how well the candidate product design satisfies one or more performance objectives for the given product, wherein the candidate product designs are generated based on the generated style grammar, the product template, and the one or more physical constraints; and
selecting, based on the set of scores for each candidate product design, the one or more candidate product designs.

18. The non-transitory, computer-readable medium of claim 15, wherein generating the set of clusters comprises, for each visual feature of the set of visual features, generating one or more clusters that each includes feature values for the group of related products.

19. The non-transitory, computer-readable medium of claim 18, wherein generating, for the group of related products, the style grammar based on the set of visual features assigned to each cluster comprises:
determining, for each given visual feature of the group of related products, a measure of importance of the given visual feature based on the feature values assigned to each cluster; and
assigning a weight to each given visual feature based on the determined measure of importance for the given visual feature.

20. The non-transitory, computer-readable medium of claim 19, wherein the operations comprise:
for each candidate product design, determining, based on a feature value for each given visual feature of the candidate design and the weight assigned to each given visual feature, a score for the candidate design; and
selecting the one or more of the candidate designs based on the score for each candidate design.
